(19) United States
(12) Patent Application Publication
(10) Pub. No.: US 2007/0140687 A1
(43) Pub. Date: Jun. 21, 2007

(54) Photosensitive material treating apparatus

(75) Inventors: Koji Itoh, Kanagawa (JP); Hiroyuki Igarashi, Kanagawa (JP)

Correspondence Address: TAIYO CORPORATION, 401 HOLLAND LANE, #407, ALEXANDRIA, VA, 22314, US

(73) Assignee: FUJIFILM CORPORATION

(21) Appl. No.: 11/594,890

(22) Filed: Nov. 9, 2006

(30) Foreign Application Priority Data
Dec. 15, 2005 (JP) 2005-330134

(51) Int. Cl. G03D 13/00; G03D 3/08

(52) U.S. Cl. 396/624

(57) ABSTRACT

A photosensitive material treating apparatus comprises a bulkhead provided between a plurality of treating tanks in which treating liquid is stored, and having an opening through which a photosensitive material is passed, an elastic blade which abuts against an opening wall of the opening to close the opening, arresting leakage of the treating liquid and, at the same time, which is elastically deformed to allow a photosensitive material to be passed, and a mounting member for mounting the elastic blade on a peripheral wall of the opening. The mounting member has a smaller linear expansion coefficient than that of the elastic blade, and is integrally formed with the elastic blade.

### CROSS-REFERENCE TO RELATED APPLICATION

This application claims priority under 35 USC 119 from Japanese Patent Application No. 2005-330134, the disclosure of which is incorporated by reference herein.

### BACKGROUND OF THE INVENTION

1. Field of the Invention

The present invention relates to a photosensitive material treating apparatus which performs predetermined treatment by a treating liquid stored in a plurality of treating tanks.

2. Description of the Related Art

In an automated developing machine (e.g. film processor, printer processor etc.) used in laboratories, treatment with a photosensitive material (e.g. film and color paper) is performed. A film and a color paper are treated by sequential conveyance in a plurality of treating tanks containing a treating liquid or water, such as coloring development, bleaching fixation, water washing and stabilization.

Since in a treating liquid in each tank, a component composition and an amount of a liquid vary depending on treatment of a film or a color paper, a system is adopted such that new liquid or water is supplemented from supplementing tanks to each treating tank depending on the amount of treatment of a film or a color paper, to maintain the composition and amount of the liquid and, in a photosensitive material treating apparatus for conveying a subject in a liquid between different treating tanks, a method of processing by partitioning a bath tank by in liquid sealing with a roller or a blade has been proposed.

For example, in Japanese Patent Application Laid-Open (JP-A) No. 2002-055422 and JP-A No. 2004-077795, an opening is formed on a bulkhead between treating tanks, and a body part having a path for conveying a photosensitive material is fitted in the opening. A blade presser is threadable on this body part, a screw is inserted in hole parts formed on a blade presser and a blade and, in the state where a blade is held by a body part and a blade presser, a blade and a blade presser are fixed on a body part.

However, in such the blade mounting method, at assembling in factories, or exchange in the after market, unless a blade is correctly inserted, it becomes a cause of liquid leakage between treating tanks, and a problem occurs in print treatment quality, and so blade mounting work has the program that it must be performed by a skilled operator.

### SUMMARY OF THE INVENTION

In view of the above facts, an object of the present invention is to provide a photosensitive material treating apparatus by which anyone can easily and precisely mount a blade without any skill being required.

A photosensitive material treating apparatus of a first aspect of the invention is a photosensitive material treating apparatus, including: a bulkhead provided between a plurality of treating tanks in which treating liquid is stored, and having an opening through which photosensitive material is passed; an elastic blade, that abuts against an opening wall of the opening to close the opening, arrests leakage of the treating liquid, and that is elastically deformed to allow passage of the photosensitive material; and a mounting member, that is mounted on a peripheral wall of the opening, has a smaller linear expansion coefficient than that of the elastic blade, and is integrated with the elastic blade.

In the photosensitive material treating apparatus of the first aspect, the opening through which the photosensitive material is passed is provided on the bulkhead between the plurality of treating tanks in which the treating liquid is stored, and the mounting member integrated with the elastic blade is mounted on the peripheral wall of the opening. And, the elastic blade abuts against the opening wall of the opening to close the opening, arresting leakage of the treating liquid. Thereby, adjacent treating liquids are prevented from being mixed. And, by elastic deformation of this elastic blade, passage of the photosensitive material becomes possible.

Like this, by integrating the elastic blade and the mounting member, since the relative positional relationship between the elastic blade and the mounting member is not changed, the elastic blade can be arranged at a prescribed position only by mounting the mounting member on the peripheral wall of the opening.

For this reason, at assembling in factories, or at exchange in the after market, anyone can easily and precisely mount the elastic plate without any skill. In addition, since an elastic blade can be arranged at the prescribed position only by mounting the mounting member on the peripheral wall of the opening, assembling property is better, and the number of assembling steps can be reduced.

Further, by adopting, as the mounting member, material having the smaller linear expansion coefficient than that of the elastic blade, a dimensional change amount of the mounting member is made to be smaller than that of the elastic blade, relative to temperature change. And, by integrating the elastic blade and the mounting member, the change in the dimension of the elastic blade relative to the temperature change can be controlled by the mounting member, and the dimensional change amount of the elastic blade can be reduced.

In the photosensitive material treating apparatus of the first aspect, as the mounting member, any one can be selected from stainless steels, titanium and Hastelloy® and, as the elastic blade, any one can be selected from silicone rubber, soft urethane, and ethylene-propylene-diene ternary copolymer rubber (EPDM).

In the above construction, as material for the mounting member, stainless steels, titanium or Hastelloy® is used and, as material for the elastic blade, silicone rubber, soft urethane or EPDM is used. Since these have both of chemical resistance and heat resistance, they are suitable for use in the photosensitive material treating apparatus.

By using silicone rubber, soft urethane or EPDM as the material for the elastic blade, the surface friction coefficient can be reduced. Since the elastic blade enables passage of the photosensitive material in the elastically deformed state, the surface of the photosensitive material is slid by the elastic blade, but since the surface friction coefficient is small, no damage is given to the photosensitive material.

In the photosensitive material treating apparatus of the first aspect, the mounting member and the elastic blade may be connected with a non-water-soluble silicone.

In the above construction, the mounting member and the elastic blade are connected with a non-water-soluble silicone. Since the non-water-soluble silicone has both of chemical resistance and heat resistance, it is possible to allow the elastic body not to be easily peeled from the mounting member.

In the photosensitive material treating apparatus of the first aspect, a groove part with which an end part of the elastic blade is engaged to control movement of the elastic blade may be provided on a peripheral wall of the opening.

In the above construction, by providing the groove part with which the end part of the elastic blade is engaged to control movement of the elastic blade on the peripheral wall of the opening, the elastic blade can be assuredly positioned. In addition, by providing the groove part on the peripheral wall of the opening, this can be a relief for the elastic blade when a dimensional difference is generated between the elastic blade and the opening wall of the opening at thermal expansion of the elastic blade. That is, the dimensional difference between the elastic blade and the opening wall is absorbed by the groove part, and occurrence of distortion (waviness, wrinkle etc.) of the elastic blade can be suppressed.

In the photosensitive material treating apparatus of the first aspect, a projection which is pressure-contacted on the peripheral wall of the opening when the mounting member is mounted on the peripheral wall of the opening may be formed on a surface of the elastic blade.

In the above construction, the projection is formed on the surface of the elastic blade, and is pressure-contacted on the peripheral wall of the opening when the mounting member is mounted on the peripheral wall of the opening. Thereby, contact between the elastic blade and the peripheral wall of the opening becomes assured and, by crushing the projection of the elastic blade, a leakage (leaking) amount of the treating liquid can be eliminated. In addition, since the planarity tolerance of the elastic blade and the peripheral wall of the opening can be absorbed by the projection, the planarity tolerance can be alleviated.

In the photosensitive material treating apparatus of the first embodiment, a dimension in a longitudinal direction of the elastic blade may be more than a dimension in a longitudinal direction of the mounting member.

In the photosensitive material treating apparatus of the first aspect, since the linear expansion coefficient of the elastic blade is greater than that of the mounting member, the dimensional change amount of the elastic blade becomes greater than that of the mounting member. For this reason, in the above construction, by making the dimension in the longitudinal direction of the elastic blade more than the dimension in the longitudinal direction of the mounting member, the elastic blade becomes inevitably in the state where it is protruded from the mounting member.

That is, also in view of the dimensional change of the elastic blade, the elastic blade inevitably abuts against the opening wall of the opening. For this reason, the leakage (leaking) amount of the treating liquid between treating tanks can be suppressed at a certain amount or below, and sealability can be improved.

Since the invention adopts the above construction, in the photosensitive material treating apparatus of the first aspect, by integrating the elastic blade and the mounting member, since relative positional relationship between the elastic blade and the mounting member is not changed, the elastic blade can be arranged at a predetermined position only by mounting the mounting member on the peripheral wall of the opening. For this reason, at assembling in factories, or at exchange in markets, anyone can mount the elastic blade easily and precisely without any skill. In addition, since the elastic blade can be arranged at the prescribed position only by mounting the mounting member on the peripheral wall of the opening, assembling property is better, and the number of assembling steps can be reduced.

Further, by adopting, as the mounting member, the material having a smaller linear expansion coefficient than that of the elastic blade, the dimensional change amount of the mounting member can be smaller than that of the elastic blade, relative to the temperature change. And, by integrally connecting the elastic blade and the mounting member, the change in a dimension of the elastic body relative to the temperature change can be controlled by the mounting member, and the dimensional change amount of the elastic blade can be reduced.

In the case where as the mounting member, any one is selected from stainless steels, titanium, and Hastelloy® and, as the elastic blade, any one is selected from silicone rubber, soft urethane, and ethylene-propylene-diene ternary copolymer rubber (EPDM), since materials for the mounting member and the elastic blade have both of chemical resistance and heat resistance, they are suitable for use in the photosensitive material treating apparatus. In addition, by using silicone rubber, soft urethane or EPDM as the material for the elastic blade, the surface friction coefficient can be reduced. Since the elastic blade in the elastically deformed state allows the photosensitive material to be passed, the surface of the photosensitive material is slid by the elastic blade, but since the surface friction coefficient is small, no damage is given to the photosensitive material.

In the case where the mounting member and the elastic blade are connected with non-water-soluble silicone, since non-water-soluble silicone has both of chemical resistance and heat resistance, it is possible to allow the elastic blade not to be easily peeled from the mounting member.

In the case where the groove part with which the end part of the elastic blade is engaged to control movement of the elastic blade is provided on the peripheral wall of the opening, the elastic blade can be assuredly positioned and, at the same time, by abutting the groove part and the elastic blade, sealability between treating tanks can be improved. In addition, this can be a relief for the elastic blade when the dimensional difference is generated between the elastic blade and the opening wall of the opening at thermal expansion of the elastic blade. That is, the dimensional difference between the elastic blade and the opening wall is absorbed by the groove part, and occurrence of distortion (waviness, wrinkle etc.) of the elastic blade can be suppressed.

In the case where the projection is formed on the surface of the elastic blade and, when the mounting member is mounted on the peripheral wall of the opening, this projection is pressure-contacted on the peripheral of the opening, contact between the elastic blade and the peripheral wall of the opening becomes assured and, by crushing the projection of the elastic blade, the leakage (leaking) amount of the treating liquid can be eliminated. In addition, since the planarity tolerance between the elastic blade and the peripheral wall of the opening can be absorbed, the planarity tolerance can be alleviated.

In the case where the dimension of the elastic blade in the longitudinal direction is more than the dimension of the mounting member in the longitudinal direction, also in view of the dimensional change of the elastic blade, since the elastic blade inevitably abuts against the opening wall of the opening, the leakage (leaking) amount of the treating liquid between treating tanks can be suppressed at the certain amount or below, and sealability can be improved.

### BRIEF DESCRIPTION OF THE DRAWINGS

FIG. 1 is a schematic constitutional view of a printer processor provided with the photosensitive material treating apparatus relating to an embodiment of the present invention.

FIGS. 2A and 2B show the state where photosensitive recording papers are connected and, FIG. 2A is a plane view, and FIG. 2B is a cross-sectional view.

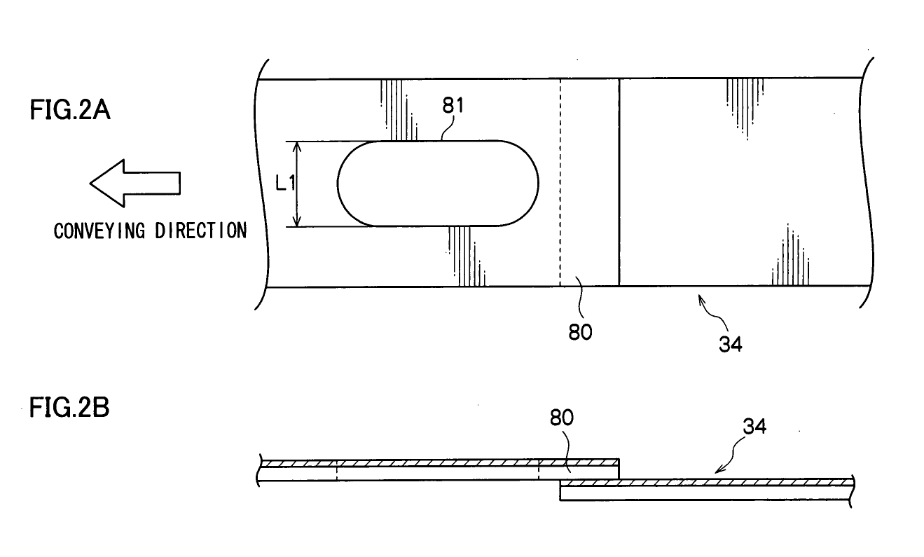

FIG. 3 is a schematic constitutional view of the photosensitive material treating apparatus relating to the embodiment of the invention.

FIG. 4 is a cross-sectional view showing a passageway member of the photosensitive material treating apparatus relating to the embodiment of the invention.

FIG. 5 is a cross-sectional view showing the passageway member of the photosensitive material treating apparatus relating to the embodiment of the invention.

FIG. 6 is an exploded perspective view showing the passageway member and a mounting member of the photosensitive material treating apparatus relating to the embodiment of the invention.

FIG. 7 is an exploded perspective view showing the mounting member and an elastic blade of the photosensitive material treating apparatus relating to the embodiment of the invention.

FIG. 8 is a perspective view showing the state where the mounting member and the elastic blade of the photosensitive material treating apparatus relating to the embodiment of the invention are connected.

FIG. 9 is an expanded view showing a projection of the elastic blade of the photosensitive material treating apparatus relating to the embodiment of the invention.

### DETAILED DESCRIPTION OF THE INVENTION

The photosensitive material treating apparatus relating to one embodiment of the present invention will be explained below.

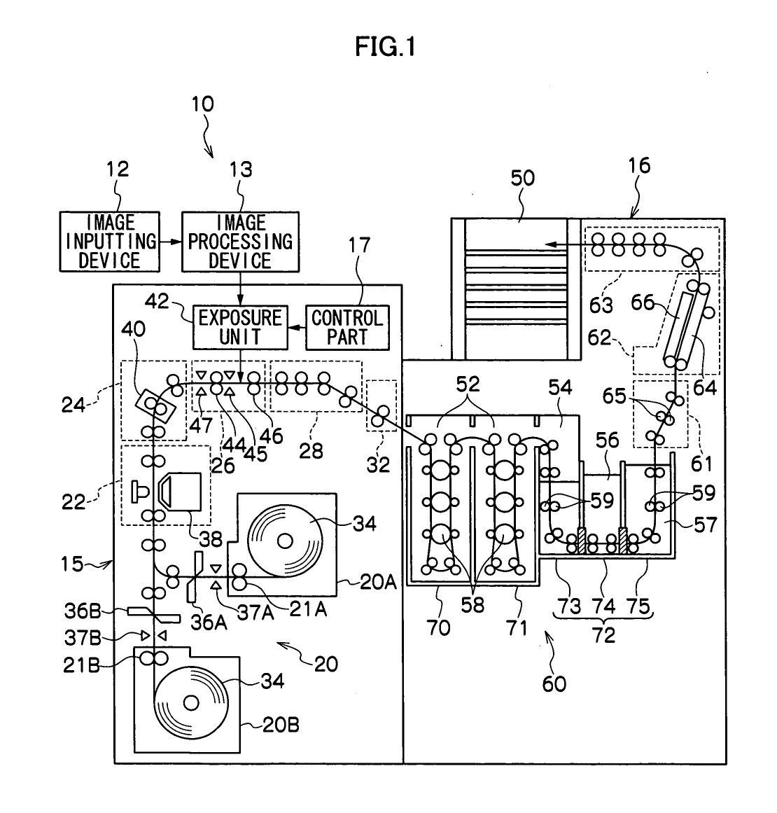

FIG. 1 shows printer processor 10 provided with stabilizing tank 72, as a photosensitive material treating apparatus. This printer processor 10 is provided with image inputting device 12, image processing device 13, printer 15 and processor 16, each part constituting printer processor 10 is connected to controlling part 17 via wiring not shown, and motion of printer processor 10 as a whole is controlled by control part 17.

Image inputting device 12 produces image data by photoelectrically reading projected light of an image recorded on a photographic film using an image pickup such as a CCD image sensor, or obtain image data by reading out image data recorded in a recording medium such as a memory card. This image data is sent to image processing device 13, and image processing such as color balance correction and concentration correction is performed. And, image-processed image data is sent to printer 15.

Printer 15 performs image recording with intensity-modified recording light based on image data while cut recording paper cut to a prescribed length is conveyed, and is provided with supplying part 20, back printing part 22, registration part 24, image recording part 26, and sub-scan receiving part 28, and conveying out part 32 from the upstream side of a conveying direction. And, in each site, plurality of conveying roller pairs constructed of a driving roller and a nip roller are provided, and the cut recording paper is conveyed along the conveying path.

Herein, magazines 20A and 20B for accommodating continuous photosensitive recording paper 34 wound in a roll-like are set on supplying part 20. In the present example, two magazines 20A and 20B are provided, but one magazine is enough, or three or more magazines may be used.

On photosensitive recording paper 34 accommodated in these magazines 20A, 20B, as shown in FIGS. 20A and 20B, connection part 80 in which end parts of photosensitive recording paper 34 are connected is provided in order to eliminate processing loss of manufacturing steps. And, splice hole 81 indicating identification of connection part 80 is provided on connection part 80. This splice hole has width L1 of, for example, 20 mm.

Outlets of magazines 20A, 20B are provided with cutters 36A, 36B for cutting photosensitive recording paper 34, respectively. Cutters 36A, 36B are driven by receiving a controlling signal from control part 17, and cut photosensitive recording paper 34 which has been delivered by a prescribed length in conformity with a print size to form the cut recording paper.

As the print size, for example, there are L (89×127), panorama (89×254), 2L (217×178), octavo (165×216), hexavo (203×254), and quarter (254×305), and the present example corresponds to cut recording papers having a width in a direction orthogonal with a conveying direction of 89, 95, 102, 117, 120, 127, 130, 152, 165, 178, 203, 210, 216, 254 and 305. In any cases, unit is mm.

Upstream of cutters 36A, 36B, splice sensors 37A, 37B for detecting splice hole 81 provided on photosensitive recording paper 34 to output a signal to control part 17 are provided, respectively, and, when these splice sensors 37A, 37B detect splice hole 81, control part 17 drives cutters 36A, 36B after photosensitive recording paper 34 having a prescribed length has been fed.

And, the cut recording paper containing connection part 80 is discharged as it is to a sorter 50 without back printing or image recording. In the present embodiment, a guillotine-type cutter is used but the invention is not limited to this, and the known means such as a rotary cutter using a rotating blade may be used.

Then, back printing part 22 is provided with back printing heat 38 for recording printing information such as a photographing date of a photograph, a printing date, a frame number, and various IDs on a non-recording surface (surface opposite to exposing surface) of the cut recording paper. As back printing head 38, the known printing head such as a dot impact head, an ink jet head, and a thermal transference printing head may be used as far as it has resistance to wet developing treatment which is performed later.

And, a registration part 24 is constructed of registration roller pair 40 for adjusting inclination of, and a position in a width direction of the cut recording paper, and a plurality of conveying roller pairs arranged before and after this registration roller pair 40, in order to prevent slippage of position and angle of exposure in image recording part 26. As a method of adjusting inclination and the position in the width direction by registration roller pair 40, known methods such as tilt registration, top registration and side registration can be used.

Further, image recording part 26 is constructed of exposing unit 42, sub-scanning roller pair 44, 46, and recording paper sensor 45 for detecting passage of the cut recording paper, and operation thereof is controlled by controlling part 17.

Exposing unit 42 is connected to image processing device 13 and, when recording paper sensor 45 has detected that a tip of the cut recording paper has passed, the unit scans light beams LB of red, green and blue, intensity of which has been modulated based on image data, in a main scanning direction (direction orthogonal to the conveying direction), and records an image on the cut recording paper.

Sub-scanning roller pair 44, 46 is arranged on the upstream side and on the downstream side in a conveying direction so as to sandwich a position of exposure with light beam LB, and conveys the cut recording paper towards the sub-scanning direction (direction parallel with the conveying direction) at a prescribed rate.

A nip roller of sub-scanning roller pair 44, 46 is switchable between a position of nipping the cut recording paper and a position away from the cut recording paper and, when the front edge or rear edge of the cut recording paper is detected by positioning sensor 47, the operation of the rollers is switched. Thereby, excessive impact due to collision of the front edge of the cut recording paper against sub-scanning roller pair 46 on the downstream side, or coming out of the rear edge from sub-scanning roller pair 44 on the upstream side is prevented from being applied to the cut recording paper.

On the other hand, sub-scanning receiving part 28 is provided with a plurality of roller pairs for retaining the front part of the cut recording paper delivered from image recording part 26 during image recording, and delivers the cut recording paper towards the downstream side at the same rate as the conveying rate by image recording part 26. Each roller pair of sub-scanning receiving part 28 consists of a driving roller, and a nip roller capable of releasing the nip, and holds the cut recording paper after the front edge of the cut recording paper during image recording has passed. Thereby, variation in the conveying rate due to collision of the front edge of the cut recording paper is prevented.

In addition, conveying out part 32 conveys the cut recording paper sent from sub-scanning receiving part 28 to processor 16 at a rate corresponding to the processing rate of processor 16.

This processor 16 is constructed of development processing part 60, squeezing part 61, drying processing part 62, conveying out part 63 and sorter 50, and coloring developing tank 70, bleaching fixing tank 71, and stabling tank 72 consisting of first stabilizing tank 73, second stabilizing tank 74 and third stabilizing tank 75 are provided in development processing part 60 in this order from the upstream side in the conveying direction. In the present embodiment, the cut recording paper is conveyed with the emulsion agent surface on the upper side, and the support on the lower side.

Coloring developer is stored in coloring developing tank 70, bleaching fixing liquid is stored in bleaching fixing tank 71, and stabilization treating liquid is stored in first stabilizing tank 73 through third stabilizing tank 75, respectively, at a prescribed amount and, by conveying the cut recording paper in each treating tank 70 to 72 with a plurality of conveying rollers 58 and nip rollers 59 disposed in conveying racks 52, 54, 56, 57 provided in developing tank 70, bleaching fixing tank 71, and first stabilizing tank 73 through third stabilizing tank 75, respectively, each treatment of developing, fixation and stabilization is performed.

In addition, squeezing part 61 is disposed above third stabilizing tank 75, and is constructed of conveying roll pair 65 and a guide (not shown). Liquid attached on the cut recording paper is squeezed and scraped down with conveying roll pair 65, and bringing of the attached liquid into a next drying step is reduced.

And, drying processing part 62 is arranged above squeezing part 61, and is constructed of conveying belt 64 and blast duct 66. Blast duct 66 blows out a dried wind heated with a heater towards conveying belt 64, to push the cut recording paper against conveying belt 64 side. By passage in front of blast duct 66 in this state, the treating liquid attached on the cut recoding paper is completely removed. And, the cut recording paper which has passed through drying processing part 62 is sent to sorter 50 by conveying out part 63.

Then, a structure of stabilizing tank 72 will be explained.

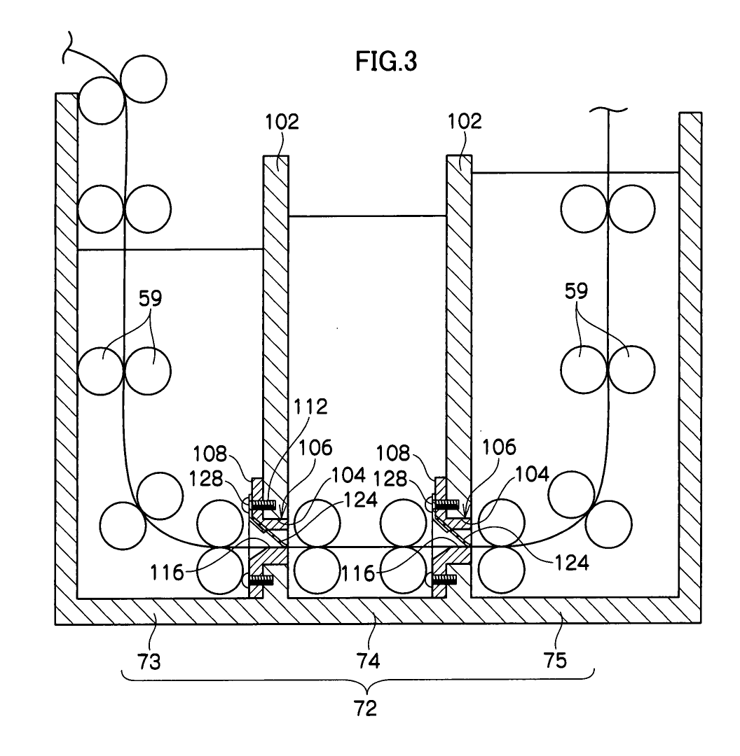

In first stabilizing tank 73, second stabilizing tank 74, and third stabilizing tank 75 constituting stabilizing tank 72 as the photosensitive material treating apparatus, as shown in FIGS. 3 to 6, bulkhead 102 is provided between respective stabilizing tanks 73, 74 and 75, and rectangular holes 104 communicating between respective stabilizing tanks 73, 74 and 75 are formed, respectively, at a lower part of bulkhead 102.

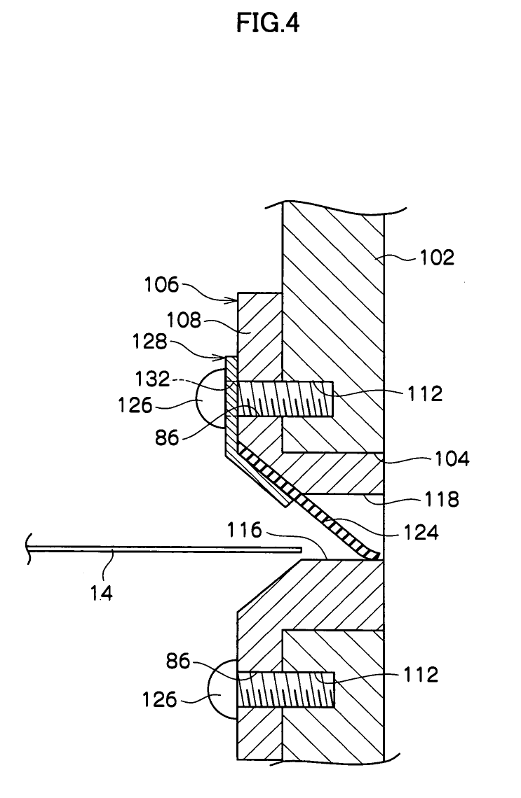

In this rectangular hole 104, passageway member 106 permitting passage of the cut recording paper 14 (see FIG. 4) is provided. Passageway member 106 is generally a rectangular parallelepiped, an upper end side and a lower end side are flange parts 108 and, in the state where a central part of passageway member 106 is fitted in rectangular hole 104, flange part 108 can abut against the peripheral wall of rectangular hole 104. A plurality of concave parts 109 are provided, this prevents surface sink and deformation after molding, stabilizing a dimension of passageway member 106.

Herein, passageway member 106 is formed of synthetic resin (e.g. PC, PPE, ABS, PPS etc.) containing glass fiber, and is provided with photosensitive material conveying path 116 allowing cut recording paper 14 to be passed. Like this, by molding passageway member 106 with the synthetic resin containing the glass fiber, the linear expansion rate can be reduced as compared with the member molded with the synthetic resin containing no glass fiber, and cause for occurrence of distortion can be decreased.

Photosensitive material conveying path 116 is provided with slit hole part 118 (opening) of a constant width h₁ which is formed long along a width direction (direction orthogonal to the conveying direction) of cut recording paper 14, and insert part 120 which is provided on an upper side of this slit hole part 118, and has a gradually increasing width in an upper and lower direction towards an upstream side, lower wall surface 118A and upper wall surface 118B of slit hole part 118 are formed horizontal, respectively, and cut recording paper 14 (see FIG. 4) is passed through this slit hole part 118.

On the other hand, upper wall surface 120B of insert part 120 is inclined at angle θ₁ relative to a conveyance plane (horizontal) of cut recording paper 14, and lower wall surface 120A of insert part 120 is inclined at angle θ₂ relative to a conveyance plane (horizontal) of cut recording paper 14. Herein, angle θ₁ and angle θ₂ are preferably in a range of 10° to 80°, and particularly preferably in a range of 10° to 30°. Slit hole part 118 is opened on upper wall surface 120B of insert part 120.

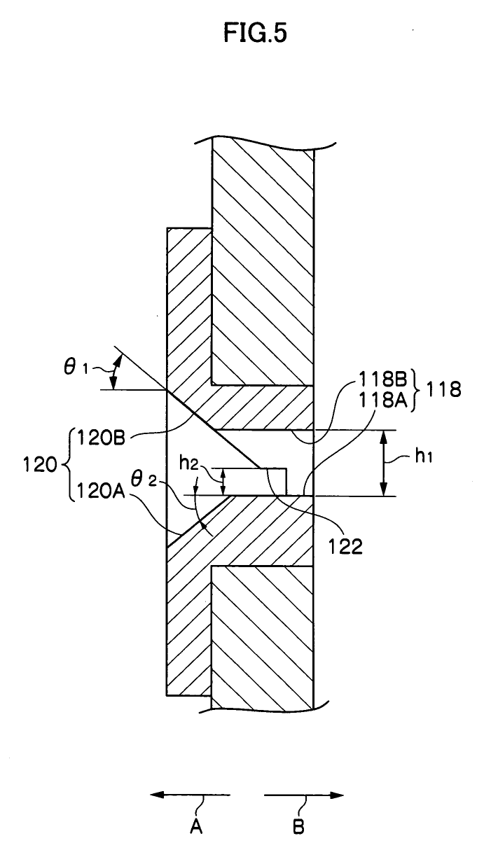

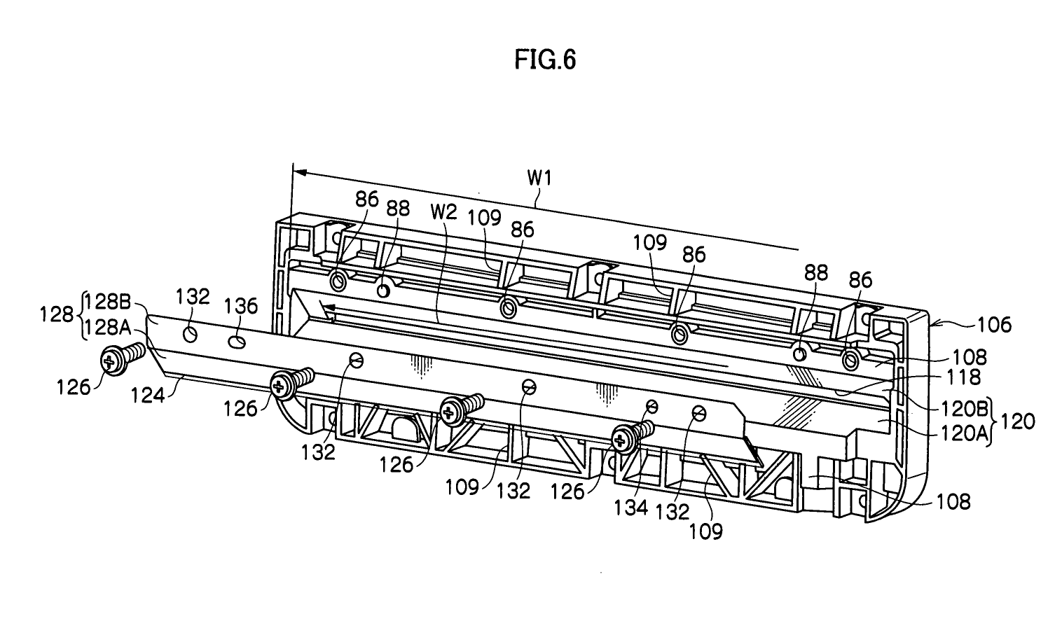

As shown in FIG. 6, dimension W₁ in a longitudinal direction of insert part 120 (upper wall surface 120B, lower wall surface 120A) is set to be greater than dimension W₂ in a longitudinal direction of slit hole 118. As shown in FIG. 5 and FIG. 6, around both ends in the longitudinal direction of insert part 120, groove part 122 is formed parallel with lower wall surface 118A of slit hole part 118 towards a downstream side (arrow B direction side) in the conveying direction from an intersection part of upper wall surface 120B and lower wall surface 120A.

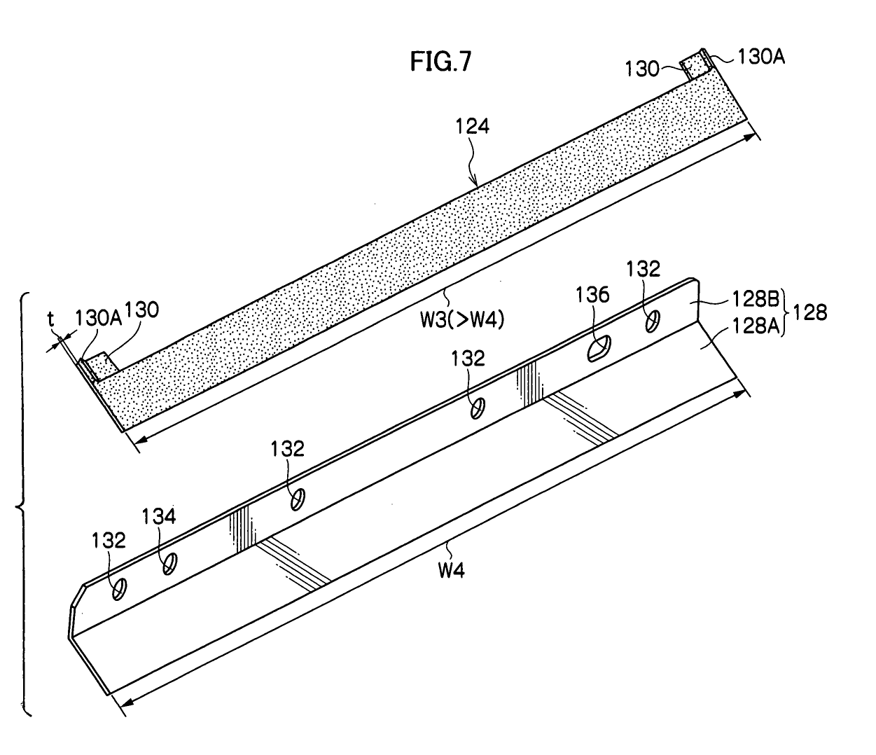

Width h₂ of this groove part 122 is set to be greater (by about 0.01 to 0.5 mm) than thickness t (see FIG. 7) of elastic blade 124 described later, and movement of elastic blade 124 is restricted in the state where both end parts of elastic blade 124 are engaged on groove part 122.

Herein, thickness t of elastic blade 124 is 0.5 mm in this case, and around 0.3 to 0.7 mm is preferable. It is preferable that a difference between width h₂ of groove part 122 and thickness t of elastic blade 124 is as small as possible in such a range that relative movement of elastic blade 124 is permitted.

In addition, dimension W₁ in a longitudinal direction of inserted part 120 is set to be slightly greater (0.1 to 1.5 mm) than dimension W₃ in a longitudinal direction of elastic blade 124. In the present embodiment, since the linear expansion coefficient of elastic blade 124 is greater than the linear expansion coefficient of passageway 106, by making dimension W₁ of insert part 120 slightly greater than dimension W₃ of elastic blade 124, distortion (waviness, wrinkle etc.) due to thermal expansion of elastic blade 124 and strong contact of both end parts with side wall 82C on longitudinal direction both sides of insert part 120 is prevented.

Meanwhile, as shown in FIG. 6, on flange part 108 of passageway member 106, a plurality of screw holes 86 into which pillar projection 88 and fixing screw 126 are threadable are formed along the longitudinal direction of passageway member 106.

In addition, mounting member 128 made of a metal plate formed in a dogleg bent manner can be fixed on flange part 108 of passageway member 106 and, as material for mounting member 128, the metal which is excellent in chemical resistance and heat resistance such as stainless steels, titanium and Hastelloy® is selected.

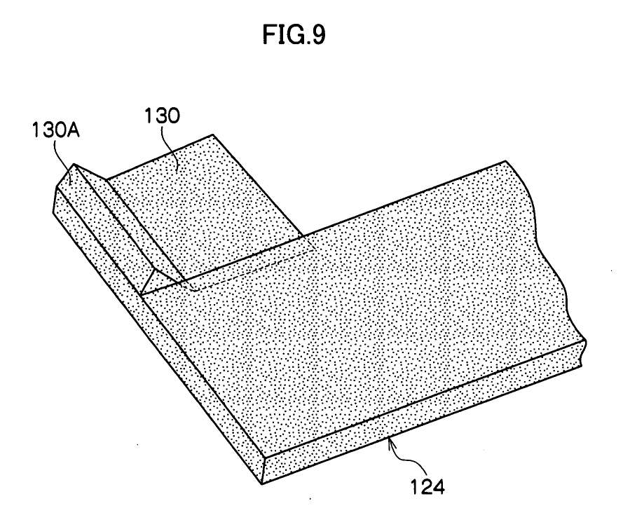

Herein, as shown in FIG. 7 to FIG. 9, thin sheet-like elastic blade 124 of constant thickness and formed in a rectangular parallelepiped is connected on an internal surface side of other pieces 128A of mounting member 128 via a non-water-soluble silicone agent, thereby, elastic blade 124 is integrated with mounting member 128.

As a material for this elastic blade 124, an elastic member which is excellent in chemical resistance and heat resistance such as silicone, urethane, ethylene-propylene-diene ternary copolymer (so-called EPDM) and the like is selected.

And, dimension W₃ in the longitudinal direction of elastic blade 124 is longer than dimension W₄ in the longitudinal direction of mounting member 128, thereby, realizing the state where the end part of elastic blade 124 is always protruded from the end part of mounting member 128. In the present embodiment, a length of elastic blade 124 is longer than that of mounting member 128 by about 0.35 mm, and the end part protrudes on one side by about 0.17 to 0.18 mm.

In addition, square-shaped abutting pieces 130 project at both end parts of elastic blade 124 along a width direction of elastic blade 124, and are arranged on the piece 128B side. Projections 130A of a height of 0.5 mm or less having a triangular-shaped cross-section protrude at an external edge part of these abutting pieces 130 along the extending direction of abutting pieces 130.

Further, as shown in FIG. 6, insertion hole 132 through which fixing screw 126 can be inserted, and round hole 134 and long hole 136 through which projection 88 can be inserted are formed on one piece 128B of mounting member 128 along the longitudinal direction of mounting member 128, and long hole 136 is formed along the longitudinal direction of mounting member 128.

Round hole 134 and long hole 136 position mounting member 128 at flange part 108 of passageway member 106 via projection 88 in the state where elastic blade 124 is faced on passageway member 106 side and, thereafter, by inserting fixing screw 126 into insertion hole 132 to screw into screw hole 86, mounting member 128 can be fixed on flange part 108 of passageway member 106.

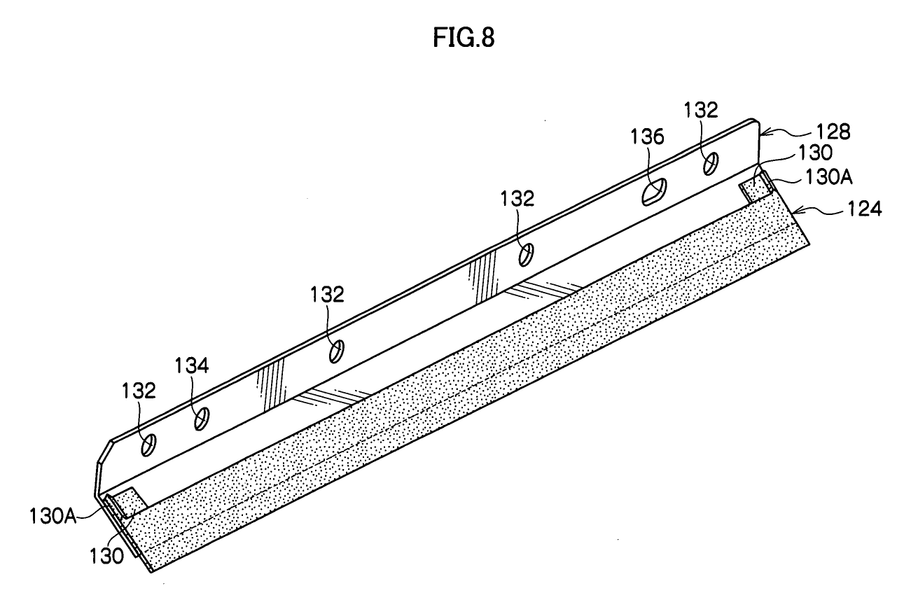

Like this, in the state where mounting member 128 is fixed on passageway member 106, elastic blade 124 is brought into the state where it is held by mounting member 128 and passageway member 106, and elastic blade 124 is abutted against upper wall surface 120B of passageway member 106 in the state where projection 130A (see FIG. 8) of elastic blade 124 is squeezed.

Meanwhile, as shown in FIG. 4, screw hole 112 is formed at peripheral part of rectangular hole 104 of bulkhead 102, allowing fixing screw 126 to be screwed. And, in the state where fixing screw 126 is screwed, mounting member 128 is fixed on passageway member 106 and, at the same time, passageway member 106 is fixed on bulkhead 102. In addition, a gasket made of an elastic sheet such as rubber and the like is held between passageway member 106 and bulkhead 102 (not shown), thereby, leakage of the stabilization treating liquid is prevented.

Herein, mounting positions of mounting member 128 and passageway member 106, and mounting positions of passageway member 106 and bulkhead 102 are the same, fixing screw 126 is allowed to be inserted or screwed in insertion hole 132 of mounting member 128, screw hole 86 of passageway member 106 and screw hole 112 of bulkhead 102, thereby, mounting member 128 and passageway member 106 can be fixed on bulkhead 102 with one fixing screw, but only mounting member 128 may be detachable on passageway member 106 by changing mounting positions of mounting member 128 and passageway 106, and mounting positions of passageway member 106 and bulkhead 102.

Then, action of the photosensitive material treating apparatus relating to the embodiment will be explained.

In printer processor 10 shown in FIG. 1, cut recording paper 14 (see FIG. 4) immersed in developer of developing tank 70 is thereafter immersed in the fixing liquid of bleaching fixing tank 71, and is conveyed to first stabilizing tank 73. And, cut recording paper 14 sent into first stabilizing tank 73 is immersed in the stabilization treating liquid stored in first stabilizing tank 73, thereafter, conveyed towards second stabilizing tank 74 with nip roller 59, passed between elastic blade 124 and lower wall surface 118A of slit hole part 118 while sliding, by deforming elastic blade 124, and is conveyed to second stabilizing tank 74.

After passage of cut recording paper 14, an edge of a lower side of elastic blade 124 is pushed against lower wall surface 118A of slit hole part 118 to adhere thereto, thereby, leakage of the treating liquid is arrested. Thereby, adjacent treating liquids are not mixed. Thereafter, cut recording paper 14 is similarly passed through each passageway member 106, immersed in each stabilization treating liquid of second stabilizing tank 74 and third stabilizing tank 75, and is conveyed to squeezing part 61 with nip roller 59.

In printer processor 10 of the embodiment, the stabilization treating liquid is replenished by a so-called cascade manner and, for example, depending on a treatment amount of cut recording paper 14, fresh stabilization treating liquid is replenished into third stabilizing tank 75 on a downmost side in the conveying direction of cut recording paper 14.

In the embodiment, mounting member 128 shown in FIG. 4 to FIG. 8 is made of metal such as stainless steels, titanium, Hastelloy® and the like, and elastic blade 124 is made of a soft member such as silicone, urethane, EPDM and the like. That is, mounting member 128 is made of material having a smaller linear expansion coefficient than that of elastic blade 124, and elastic blade 124 and mounting member 128 are integrally connected with non-water-soluble silicone.

Like this, by making mounting member 128 of the material having the smaller linear expansion coefficient than that of elastic blade 124, a dimensional change amount of mounting member 128 is made to be smaller than that of elastic blade 124, relative to a temperature change. And, by integrally connecting elastic blade 124 and mounting member 128, the change in a dimension of elastic blade 124 relative to the temperature change can be controlled by mounting member 128, and a dimensional change amount of elastic blade 124 can be reduced.

In addition, by integrally connecting elastic blade 124 and mounting member 128, since a relative positional relationship between elastic blade 124 and mounting member 128 is not changed, elastic blade 124 can be arranged at a prescribed position of passageway member 106 only by mounting mounting member 128 on flange part 108 of passageway member 106.

For this reason, at assembling in factories, or at exchange in markets, anyone can mount elastic blade 124 easily and precisely without any skill being required. In addition, only by mounting mounting member 128 on flange part 108 of passageway member 106, since elastic blade 124 can be arranged at a prescribed position, assembling property is better, and the number of assembling steps is reduced.

Further, in the embodiment, mounting member 128 and elastic blade 124 are connected with the non-water-soluble silicone. Since the non-water-soluble silicone has both of chemical resistance and heat resistance, elastic blade 124 can be allowed not to easily peeled from mounting member 128.

In addition, by using material having the smaller linear expansion coefficient than that of elastic blade 124 as mounting member 128, the dimensional change amount of mounting member 128 is made to be smaller than that of elastic blade 124, relative to the temperature change. And, by integrally connecting elastic blade 124 and mounting member 128, the change in a dimension of elastic blade 124 relative to the temperature change can be controlled by mounting member 128, and the dimensional change amount of elastic blade 124 can be reduced.

In addition, dimension W₃ in the longitudinal direction of elastic blade 124 is not less than dimension W₄ in the longitudinal direction of mounting member 128. Since the linear expansion coefficient is greater in elastic blade 124 than in mounting member 128, the dimensional change amount of elastic blade 124 becomes greater than that of mounting member 128. For this reason, by making dimension W₃ in the longitudinal direction of elastic blade 124 not less than dimension W₄ in the longitudinal direction of mounting member 128, elastic blade 124 is inevitably brought into the state where it is protruded from mounting member.

That is, also in view of the dimensional change of elastic blade 124, elastic blade 124 is assuredly abutted against side walls 82C on longitudinal direction both sides of insertion part 120 of passageway member 106. For this reason, a leakage (leaking) amount of treating liquid between respective stabilizing tanks 73, 74 and 75 can be suppressed at a constant amount or less, and sealability can be improved.

Further, by using silicone rubber, soft urethane, or EPDM as the material for elastic blade 124, the surface friction coefficient can be reduced. Since elastic blade 124 allows cut recording paper 14 to be passed in the elastically deformed state, a surface of the cut recording paper 14 is slid by elastic blade 124, but since the surface friction coefficient of elastic blade 124 is small, no damage is given to cut recording paper 14.

In addition, by providing groove part 122 with which the end part of elastic blade 124 is engaged to restrict movement of elastic blade 124 on the upper wall surface 120B of insertion part 120, elastic blade 124 can be assuredly positioned.

In addition, by providing groove part 122 on upper wall surface 120B of insertion part 120, this act as a relief for elastic blade 124 when dimensional differences are generated between elastic blade 124 and side wall 82C on longitudinal direction both sides of insertion part 120 at thermal expansion of elastic blade 124. That is, dimensional differences between elastic blade 124 and side wall 82C of insertion part 120 are absorbed by groove part 122, and occurrence of distortion (waviness, wrinkle etc.) of elastic blade 124 can be suppressed.

Further, by protruding projection 130A at an external edge of abutting pieces 130 of elastic blade 124, so as to abut against upper wall surface 120B of insertion part 120, contact between elastic blade 124 and insertion part 120 becomes assured and, by squeezing projection 130A of elastic blade 124, a leakage (leaking) amount of treating liquid can be eliminated. In addition, since a surface tolerance of elastic blade 124 and insertion part 120 can be absorbed by projection 130A, the surface tolerance can be relaxed.

In the above embodiment, passageway member 106 was used for bulkhead 102 between stabilizing tanks, but may be used for the bulkhead between other treating tanks. In addition, in the present embodiment, rectangular hole 104 was formed at bulkhead 102, and passageway member 106 was fitted in rectangular hole 104, but rectangular hole 104 itself may be an opening, and mounting member 128 may be directly mounted on peripheral wall of rectangular hole 104.

In addition, herein, elastic blade 124 was abutted against upper wall surface 120B of passageway member 106 in the state where mounting member 128 was fixed on passageway member 106, but in the invention, since it is an essential feature that elastic blade 124 for closing slit hole part 128 to arrest leakage of the treating liquid is integrated with mounting member 128, it is not necessarily required that it is abutted against upper wall surface 120B of passageway member 106.

Further, in the present embodiment, mounting member 128 and elastic blade 124 were connected with the non-water-soluble silicone, but it is enough that mounting member 128 and elastic blade 124 can be integrated, and is not limited to the above. For example, integration by insert molding can be used.

What is claimed is:

1. A photosensitive material treating apparatus, comprising:
a bulkhead provided between a plurality of treating tanks in which treating liquid is stored, and having an opening through which photosensitive material is passed;
an elastic blade, that abuts against an opening wall of the opening to close the opening, arrests leakage of the treating liquid, and that is elastically deformed to allow passage of the photosensitive material; and
a mounting member, that is mounted on a peripheral wall of the opening, has a smaller linear expansion coefficient than that of the elastic blade, and is integrated with the elastic blade.

2. The photosensitive material treating apparatus according to claim 1, wherein the mounting member is formed from material selected from any one of a stainless steel, titanium and a Hastelloy®, and the elastic blade is formed from material selected from any one of a silicone rubber, a soft urethane, and a ethylene-propylene-diene ternary copolymer rubber.

3. The photosensitive material treating apparatus according to claim 1, wherein the mounting member and the elastic blade are connected with a non-water-soluble silicone.

4. The photosensitive material treating apparatus according to claim 1, wherein, on a peripheral wall of the opening, a groove part is provided with which an end part of the elastic blade is engaged and that restricts movement of the elastic blade.

5. The photosensitive material treating apparatus according to claim 1, wherein a projection is formed on a surface of the elastic blade that is pressure-contacted with the peripheral wall of the opening when the mounting member is mounted on the peripheral wall of the opening.

6. The photosensitive material treating apparatus according to claim 1, wherein a dimension in a longitudinal direction of the elastic blade is the dimension in a longitudinal direction of the mounting member or greater.

7. The photosensitive material treating apparatus according to claim 1, wherein the mounting member and the elastic blade are integrally formed by insert molding.

8. The photosensitive material treating apparatus according to claim 1, wherein the elastic blade closes the opening so that an end part thereof in a longitudinal direction is abutted against a longitudinal direction end part side wall of the opening.

9. The photosensitive material treating apparatus according to claim 1, wherein the bulkhead comprises a passageway member, the passageway member has a hole part through which the photosensitive material is passed, and is mounted on the bulkhead so as to cover at least a part of the opening, and the mounting member is mounted on a peripheral wall of a hole part of the passageway member.

10. A photosensitive material treating apparatus, comprising:
a bulkhead, provided between a plurality of treating tanks in which treating liquid is stored, and in which an opening is formed through which photosensitive material is passed between the treating tanks;
a passageway member, having a hole part through which the photosensitive material is passed, and which is mounted on the bulkhead so as to cover at least a part of the opening;
an elastic blade, closing the hole part to arrest leakage of the treating liquid, and being elastically deformed to allow passage of the photosensitive material;
a mounting member, mounted on a peripheral wall of a hole part of the passageway member, having a smaller linear expansion coefficient than that of the elastic blade, and being integrated with the elastic blade.

11. The photosensitive material treating apparatus according to claim 10, wherein the mounting member is selected from any one of a stainless steel, titanium, and Hastelloy®, and the elastic blade is selected from any one of a silicone rubber, a soft urethane, and a ethylene-propylene-diene ternary copolymer rubber.

12. The photosensitive material treating apparatus according to claim 10, wherein the mounting member and the elastic blade are connected with a non-water-soluble silicone.

13. The photosensitive material treating apparatus according to claim 10, wherein, on a peripheral wall of the hole part, a groove part is provided with which an end part of the elastic blade is engaged and that restricts movement of the elastic blade.

14. The photosensitive material treating apparatus according to claim 10, wherein a projection is formed on a surface of the elastic blade that is pressure-contacted with a peripheral wall of the opening when the mounting member is mounted on the peripheral wall of the hole.

15. The photosensitive material treating apparatus according to claim 10, wherein a dimension in a longitudinal direction of the elastic blade is the dimension in a longitudinal direction of the mounting member or greater.

16. The photosensitive material treating apparatus according to claim 10, wherein the mounting member and the elastic blade are integrally formed by insert molding.

17. The photosensitive material treating apparatus according to claim 10, wherein the elastic blade is mounted on a passageway member via the mounting member so that an end part of the elastic blade in a longitudinal direction is abutted against a longitudinal direction end portion side wall of the hole part.
